(19) United States
(12) Patent Application Publication
(10) Pub. No.: US 2014/0010517 A1
(43) Pub. Date: Jan. 9, 2014

(54) Reduced Latency Video Streaming

(71) Applicant: Sensr.net, Inc., Incline Village, NV (US)

(72) Inventors: Thomas J. Sheffler, San Francisco, CA (US); Adam Beguelin, San Carlos, CA (US); Yacim Bahi, Los Altos, CA (US)

(73) Assignee: Sensr.net, Inc., Incline Village, NV (US)

(21) Appl. No.: 13/934,156

(22) Filed: Jul. 2, 2013

Related U.S. Application Data
(60) Provisional application No. 61/669,155, filed on Jul. 9, 2012.
(60) Provisional application No. 61/698,704, filed on Sep. 9, 2012.

(51) Int. Cl. H04N 9/79

(52) U.S. Cl. CPC H04N 9/79
USPC 386/226; 386/224

(57) ABSTRACT

The invention described herein covers methods, apparatus and computer architectures for reducing latency for viewing live video and for archiving the video. Embodiments of the invention include video cameras that generate meta data at or near the time of video acquisition, and tag video segments with that meta data for use by the architectures of the present invention. Alternatively, a live viewing server may tag the video segments with the meta-data upon arrival.

### CROSS-REFERENCE TO RELATED APPLICATIONS

This patent application claims the benefit of U.S. Prov. Ser. No. 61/669,155 filed Jul. 9, 2012 and U.S. Prov. Ser. No. 61/698,704 filed Sep. 9, 2012.

### FIELD

The present invention relates to an architecture, system and methods for reducing the latency of viewing a video stream from the live acquisition of the video, and for generating and utilizing meta data tags at the video source on streaming video segments.

### INCORPORATION BY REFERENCE

All publications and patent applications mentioned in this specification are incorporated herein, in their entirety, by reference to the same extent as if each individual publication or patent application was specifically and individually indicated to be incorporated by reference.

### BACKGROUND

Recent developments for serving video streams over the internet have favored segmented video storage and presentation. Segmented video techniques stream and store video as a series of data packets or segments ranging in duration, for example and without limitation from 1 to 10 seconds, and orchestrate the presentation of segments through the serving of a “manifest” file. The skilled artisan will appreciate that segments may have any desired length as needs dictate. The manifest file acts like a play-list of the video arranging the segments in the proper order for playing the video. In present video camera applications designed for live as well as archived streaming and viewing of video, the pseudo-live video stream is accessed from the most recently archived segments, thereby creating an undesired latency problem between video capture and video viewing.

FIG. 1 depicts a prior art system 100 for archiving, accessing and viewing video. Referring to FIG. 1, video camera 101 obtains video and segments the data into new segment 104. The skilled artisan will appreciate that the video is segmented into many segments, but for ease of discussion one is shown in this example. Archiving system 105, comprising archive server 103 and cloud server 108, receives the new segments 104 at archive server 103. Archive server 103 comprises archive module 106 and database 110, where archive module 106 analyzes the segments, transfers the archive segment 107 to cloud server 108 and indexes the cloud location of archive segment 107 in database 110 for later access by archive server 103 when a get command is received from a viewer. As the skilled artisan will appreciate cloud server 108 is storage space independent of location of where the physical memory is located and typically does not require user back ups because the information is redundantly stored in multiple locations. Archive module 106 tags archive segment 107 with meta data as to the time (by way of example seconds since 12:00 am Jan. 1, 1970 GMT) the segment is received by archiving system 105. This meta data is stored in database 110 and also in cloud server 108. As will be appreciated, viewer 114 may request certain times of the video stream, and the meta data time tags permits searching the database for this time within the video stream and then the locating of the video segments in the cloud representing the desired time within the video in order to provide a manifest file (e.g., hour-HH.m3u8) and serve it up to viewer 114. Video camera 101, for example, is a wireless IP camera obtaining video surveillance footage of a desired location. The skilled artisan will appreciate that video may come from hard wired cameras, mobile phones, tablets, and many other video devices capable of transferring data over a network, be it local or directly to the internet. Further, the skilled artisan will appreciate that video camera 101 may communicate directly through the internet, or may be connected to a local area network (such as a home network), which is connected to the internet, and the same is true for viewer 114. In some situations viewer 114 and video camera 101 are on the same local area network. The skilled artisan will also appreciate that archiving system 105 may be separated and distributed in many different ways, i.e., there is no requirement the archive server include both archive module 106 and database 110, and further that cloud server 108 may be locate outside the archiving system. These depictions are merely for the convenience of this description.

Viewing video requires viewer 114 to get the desired segments. As will be appreciated by the skilled artisan, viewer 114 could try to get the archive data directly from the camera through the internet, which would require some complicated system configuration to remove firewalls. Alternatively and as will be appreciated by skilled artisan, camera 101 can be configured to generate the segments in a manner/form where viewer 114 can easily get the segments through the internet. When accessing video segments to display, viewer 114 gets the manifest (e.g., manifest .m3u8) which provides a play-list of the segments for the desired video stream, the order of the segments and the location of those segments in cloud server 108, then viewer 114 gets the desired segments from cloud server 108 and displays them in the order dictated by the manifest. Alternatively, the rendered video will simply be the most recent segments available in the cloud and suitably indexed in the database. Storing, archiving and retrieving segments requires time, which leads to latency between video acquisition and viewing of the video. Further, the time acquisition of the video segments may not be accurately reflected in the database and cloud. Segments 104 may arrive to archive server 106 out of order, and may be subject to internet and other processing delays, which may lead to unwanted errors in the meta data time tags placed on the segments, where the meta data time tags are placed on the segment at the time it arrives at the archive server. This may lead to an error in the time tag by virtue of the segment arriving to the archive server at a later time than when actually acquired by the camera, and further there can be delays in the transfer caused by internet interruptions (for example) in addition to the segments arriving out of order resulting in the segment being tagged by the archive server with an incorrect time relative to the other segments of the video stream.

As will be appreciated in the art of video surveillance, the ability to view reduced latency video in addition to having access to archived video for later review is important. Embodiments of the present invention provide architectures and methods for reducing latency in viewing video, archiving the same video for viewing at a later time, and for providing meta data tags for achieving the same.

### BRIEF DESCRIPTION OF THE DRAWINGS

FIG. 1 depicts a prior art architecture for archiving video data;

FIG. 2 depicts an architecture for reducing latency of viewing real time or near real time video over the internet and for archiving the same video in accordance with an embodiment of the present invention;

FIG. 3 depicts a process for tagging video segments with meta data at the video source; and

FIG. 4 depicts a process for creating meta data at the camera before transferring the segments to the live streaming servers or archiving system.

### DETAILED DESCRIPTION

The following description sets forth numerous specific details such as examples of specific systems, components, methods, and so forth, in order to provide a good understanding of embodiments of the present invention. It will be apparent to one skilled in the art, however, that at least some embodiments of the present invention may be practiced without these specific details. In other instances, well-known components or methods are not described in detail in order to avoid unnecessarily obscuring the description of the exemplary embodiments. Thus, the specific details set forth are merely exemplary. Particular implementations may vary from these exemplary details and still be contemplated to be within the spirit and scope of the present invention.

Embodiments of the present invention include various operations, which will be described below. These operations may be performed by hardware components, software, firmware, or a combination thereof. As used herein, the term “coupled to” may mean coupled directly or indirectly through one or more intervening components. Any of the signals provided over various buses described herein may be time multiplexed with other signals and provided over one or more common buses. Certain embodiments may be implemented as a computer program product which may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage media (e.g., floppy diskette); optical storage media (e.g., CD-ROM); magneto-optical storage media; read-only memory (ROM); random-access memory (RAM); erasable programmable memory (e.g., EPROM and EEPROM); flash memory; electrical, optical, acoustical, or other form of propagated signal (e.g., carrier waves, infrared signals, digital signals, etc.); or another type of media suitable for storing electronic instructions.

Additionally, some embodiments may be practiced in distributed computing environments where the machine-readable medium is stored on and/or executed by more than one computer system. In addition, the information transferred between computer systems may either be pulled or pushed across the communication medium connecting the computer systems such as in a remote diagnosis or monitoring system.

In the following description and in the accompanying drawings, specific terminology and reference numbers are set forth to provide a thorough understanding of embodiments of the present invention. In some instances, the terminology and symbols may imply specific details that are not required to practice the invention.

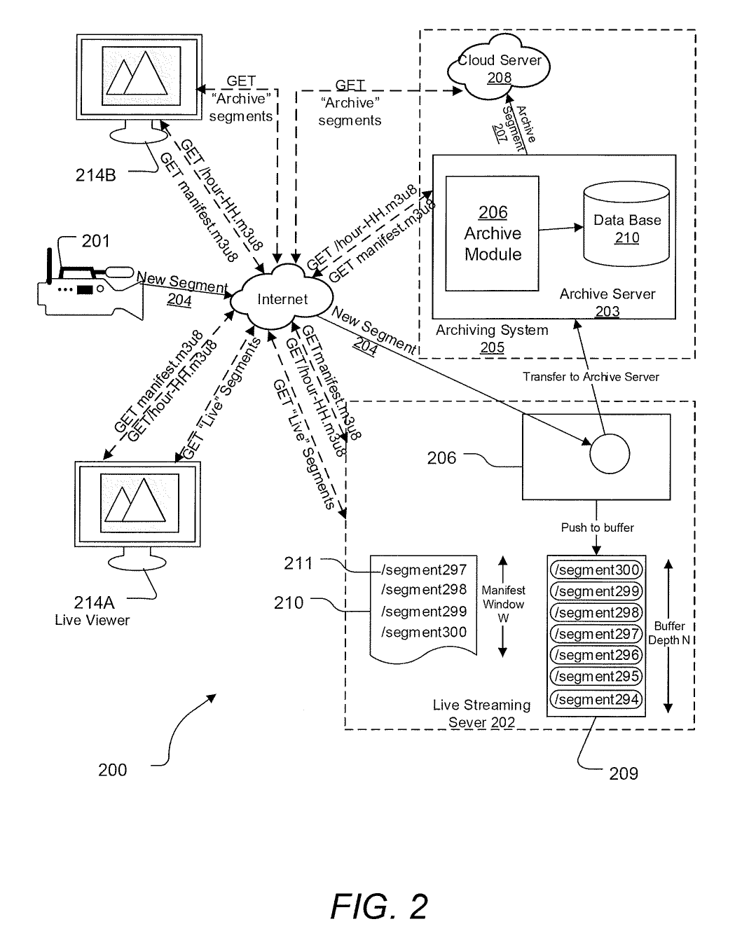

FIG. 2 illustrates a system and architecture 200 for viewing reduced latency live video and archiving the same video for viewing later in time. In general, and without limitation, system 200 serves reduced latency (referred to herein as “live”) video segments 211 from live streaming server 202, and “archived” video segments 207 are served from archiving system 205, archiving system 205 comprising cloud server 208 and archive server 203. One of skill in the art will appreciate live streaming server 202 and archive server 203 may reside in one or more than one location, or may be one or more than one computer processors in one or more locations. Video camera 201 obtains video, segments the data into new segment 204 and sends it to live streaming server 202 via the internet. Live streaming server 202 comprises transfer/push module 206, buffer 209 and live manifest 210. It will be appreciated that the transfer/push module can be a transfer module and a push module. The skilled artisan will appreciate that transfer/push module 206 may be software or firmware, and may be simply a few lines of computer code. Transfer/push module 206 sends new segment 204 to archive server 203 of archiving system 205 for processing, and pushes it to buffer 209. Pushing segment 212 to buffer 209 typically causes live manifest 210 to be updated accordingly.

In a preferred embodiment, live streaming server 202 acts as an upload receiver sending video segments to archiving system 205, as well as a viewing server which acts to serve streamed segments to viewer 214A without the need to archive the segments first before streaming for viewing. Buffer 209 holds the N most recent segments received from camera 201, where N may be selected according to needs. In the depicted example, the most recent segment received has been given sequence number 300, and this segment is available for retrieving at URL “/segment300”. Prior segments are made available at “/segment299”, “/segment298”, etc. A maximum of N segments are available at any given time within buffer 209. To reduce storage requirements on live streaming server 204, segments are “expired” from buffer 209 in FIFO order.

Live manifest file 210 is served at URL “/manifest.m3u8”, for example. This resource may be, for example, dynamically generated at each GET request from live viewer or web-browser 214A, or may be updated when new segments arrive. Live manifest file 210 lists live segments 211 at the head of the live stream; it is a window of “W” segments, where W≦N. In the example, the head of manifest list file 210 comprises segments “segment297”, “segment298”, “segment299” and “segment300”, where the window size W=4. A web-browser 214A, or other viewing software requesting the live view, composes live manifest file 210 with live segments 211 to render the video to the user. Live manifest file 210 lists only W entries, even though buffer 209 is capable of serving up to N entries. The extra capacity in buffer 209 is desired to mask race conditions in the retrieval of manifest file 210 and the expiration of segments. Tuning of the values of W and N may be based on server capacity or network conditions. The skilled artisan has a full appreciation of manifests, buffers, race conditions and tuning (see e.g., R. Pantos, Ed, HTTP Live Streaming, http://tools.ietf.org/html/draft-pantos-http-live-streaming-08, Mar. 23, 2012) and further details will not be provided here.

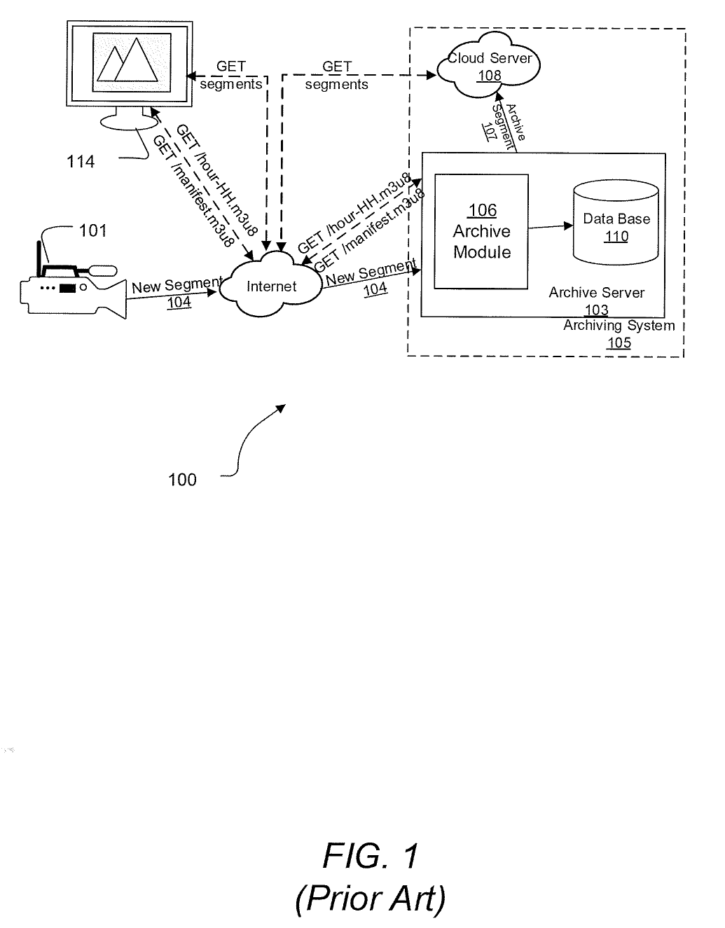

Archiving system 205 works in concert with live streaming server 202. Archive module 206 of archive server 207 analyzes each segment and decides whether to store or delete it. If selected for storage, the segment is transferred to cloud 208 and the location of the segment in the cloud is stored in database 210. Web-browser 214B or other viewing software requesting an archive view of a particular time interval will retrieve an appropriate manifest file listing the video segments of the selected time interval from archive server 203. Web-browser 214B will use the manifest file to obtain the URLs of the video segments from cloud server 216 and compose the manifest with the segments to render the video to the user, in a manner as described for the prior art system in FIG. 1. It will be appreciated that viewers and web-browsers 214A and 214B may be the same or different viewers or web-browsers.

Camera 201, in accordance with embodiments of the present invention, may obtain the video and create meta data attached to each of the segments at or close to the time of video acquisition. Creation and use of meta data is well known to the skilled artisan and can be done by firm ware, software or a combination of both residing on the camera or elsewhere or through other well known means. Meta data can include, for example and not by way of limitation, the time at which the segment is created/obtained (e.g., Dec. 31 11:59 50 seconds 2011). The time tagged for each segment depends on the length of each segment, as will be appreciated by the skilled artisan. Meta data tags attached to each segment may include other information useful to the viewer or to the storage system. For example, and not by way of limitation, camera 101 could analyze each segment to determine if motion took place (using well know means) within that segment and tag the segment with meta data indicating such (e.g., motion or no-motion), additional meta data may include environmental conditions (e.g., humidity, temperature, barometric pressures and the like) or other information from sensors on or communicating with the camera (e.g., motion sensors and heat sensors).

The meta data obtained at the time of video acquisition and used to tag the video segments serve several useful purposes. The time of acquisition tags can be used by either archive server 203 or live streaming server 202 to more accurately provide the time the segment was actually acquired. Without such, live streaming server 202 would be left to tag the segments with the time they arrived at the server. As described above, this time may be delayed and segments may arrive out of order leading to inconsistencies and imprecision regarding the time the video was actually acquired. Either archiving server 203 or live streaming server 202, more preferably the former, can use meta data, for example and without limitation, related to the absence of motion within a segment to delete that particular segment. This ability will allow for the reduction of memory necessary to store all the segments. The skilled artisan will recognize many additional uses for the meta data attached to the video segments, some of which are described herein.

Additionally, environmental sensor data (e.g., temperature, humidity etc.) may be useful in decisions regarding the presentation or highlighting of video, or useful without the video. For example, and not by way of limitation, a temperature graph of a room made from meta data of a video of a room may be used to identify and control heating within the space being video recorded. Thus, this meta data may be stored in database 210 and used as an information source with or without the video segments.

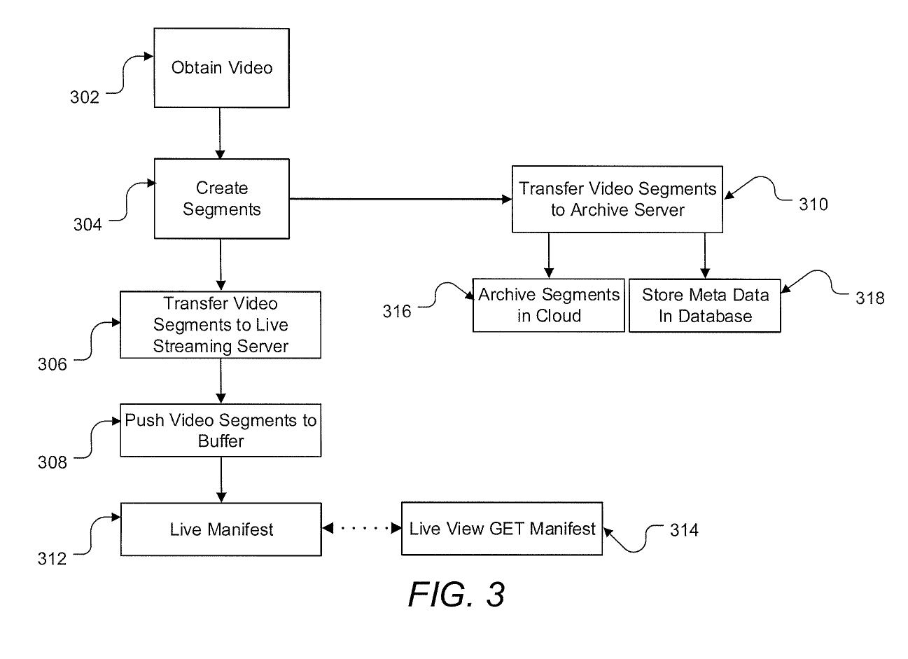

Referring to FIG. 3, a method for reducing the latency of viewing live video is shown. In step 302 video is obtained by the camera, and at step 304 the camera (or firmware or software on or connected to the camera) creates segments. A video segment can be any length of time, but preferably is about 1 second to 10 seconds in length. In step 306 the camera transfers the segments to the live streaming server using HTTP or other protocol via the internet (as will be appreciated by the skilled artisan), and step 310 transfers the segments to the archiving system. Step 308 pushes the segments to a buffer, where the segments are stored in FIFO order. The order of when segments are transferred to the archiving system and/or pushed to the buffer is a matter of design choice, or could be done simultaneously. It is preferred to push the segments to the buffer first to further reduce latency in the live view of the segments. Step 312 creates a manifest from the buffer for serving to a live viewer upon request 314 from the live viewer. The segments in the manifest will be determined and created based on the GET request from the live viewer. Step 316 archives the segments in the storage cloud, and step 318 stores meta data in a database for later query and retrieval of the stored segments. The live streaming server and the archiving system are preferably provided by a SaaS company over the internet, though the skilled artisan will recognize that dedicated servers may also be used.

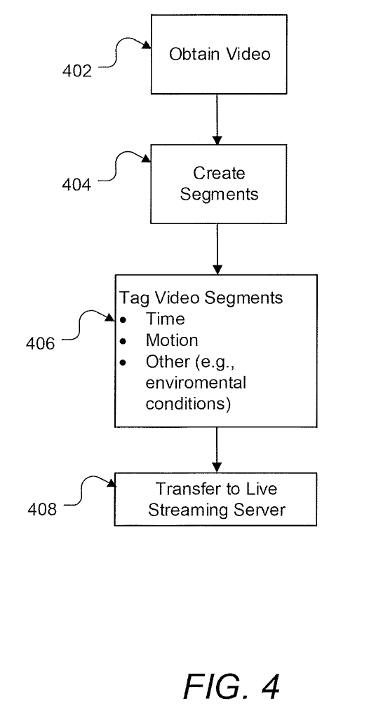

The meta data used to tag the segments and stored in the database can comprise any number of relevant information. The live server can tag the segments with meta data identifying the time the segment arrived at the live server. Referring to FIG. 4 a preferred method in accordance with embodiments of the present invention creates meta data at the camera before pushing the segments to the live streaming servers or archive server. Steps 402 and 404 are the same as steps 302 and 304 as in the method of FIG. 3. Collectively the video is acquired and segments are created by the camera. Step 406 tags the video segments with meta data. As will be appreciated by the skilled artisan, step 406 must also create or obtain the meta data from information available or generated by the camera. Examples of such meta data are the time at which the video segment was generated by the camera (a much more accurate time account of video acquisition than the time at which segments arrive at system 200). The camera may also analyze the segments, using well known techniques, to determine whether motion had taken place within the segment. This motion or no-motion information can later be used to determine whether to store segments in the archiving system 205, or which segments a user may want to view. Other data may also be included in the meta data tags such as environmental conditions when the video was acquired. The environmental data (e.g., temperature, humidity, barometric pressure etc.) can be obtained by placing sensors on or in communication with the camera. Step 408 is similar to step 306 in that it pushes the now tagged segments to the live streaming server.

Additionally, a video camera may lose connection with the network (e.g., local area network, internet etc.) for any number of reasons. In this circumstance, the camera (in accordance with embodiments of the present invention) may be able to buffer the video (or at least some portion of it depending on the length of disconnection) internally until reconnection. Upon reconnection, the camera can begin to upload its backlog of video segment data. In this ‘catch-up’ scenario, the meta data generated by the camera and attached to each segment may be used to properly arrange and store the video segments at the live streaming server.

In video camera applications, in accordance with embodiments of the present invention, designed for segmented streaming to a cloud service, the video camera may compute additional information for each segment that it could also transmit to the cloud. Such information may include the approximate time that the segment begins (relative to a Network Time Server), the location of “motion” detected by the camera, and perhaps the state of auxiliary environmental sensors attached to or in communication with the camera.

Video segment formats, for example and without limitation MPEG-TS (Transport Stream) and MP4, allow the encoder programs to write certain types of information directly into the video file itself, such as timestamps. While it is possible to use these capabilities to embed certain types of meta-information in the video segments themselves, a cloud-based HTTP upload service may want to make decisions about the routing and storage of the segments before a video decode process can be started. Video decoding is also expensive. For these reasons, it is advantageous that desired pieces of meta-data are transmitted external to the segment data itself.

### Example

This section presents a nonlimiting example describing how meta-data could be attached to video segment information in accordance with embodiments of the present invention. It will be appreciated that this may occur using a processor, software or firmware on the camera, or at the live server.

The Unix “curl” command can be used to send a video file (here called “seg01.ts”) to a server (here called “vxp01.sensr.net”) in the following way.
curl -X POST -T seg01.ts -H “Content-Type: video/mp2ts” http://vxp01.sensr.net/upload/cam446

The “-X” argument is used to specify that curl should use the “POST” HTTP method to transfer the information to the server. The “-T” argument is used to say which file to transfer to the server; here it is the example segment “seg01.ts”. The “-H” argument is used to add a header to the HTTP request. Here we use an HTTP-standard header named “Content-Type” with a standard MIME (Multipurpose Internet Mail Extensions) type of “video/mp2ts” specifying a specific type of video format called an “MPEG2 Transport Stream”.

The URL that will receive the posted segment is “http://vxp01.sensr.net/upload/cam446”—the upload portal for camera 446. The server may potentially use the content-type meta-information to make decisions about the storing and presentation of the video file “seg01.ts”.

The HTTP header mechanism is very general, and both standard and non-standard headers may be attached to an HTTP transfer. In the example above, the standard “Content-Type” header is used to attach a standardized file format label to the file. It will be appreciated that a non-standard label could also be attached, or a multiplicity of non-standard header labels.

IETF (Internet Engineering Task Force) standard “RFC3339” [http://www.ietf.org/rfc/rfc3339.txt] specifies a standard for the formatting of dates. Using the header capability of the HTTP request format, a non-standard date header may be attached to the video segment by the video camera that will provide metadata for the live streaming server to determine the acquisition time of the video segment in our system. For example, the following curl command would upload the same segment with a non-standard header called “Sensr-Date” that specifies a UTC time of Jun. 1, 2012 at 8:30 and 59 seconds, AM, the date and time at which the video segment was acquired by the camera.
curl -X POST -T seg01.ts -H “Sensr-Date: 2012-06-01T08:30:59 Z”-H “Content-Type: video/mp2ts” http://vxp01.sensr.net/upload/cam446

Note that while the HTTP standard already has a standard header called “Last-Modified” that refers to the modification time of the data file, that header carries meaning that may be different than intended by the acquisition time label. Hence, in one embodiment of the present invention it is better to avoid the standard label and use one that suits the desired purposes more clearly, e.g., the time at which the camera acquired the video segment. The HTTP standard allows the use of non-standard headers for non-standard meanings. Embodiments of the present invention exploit this meta-data tagging capability.

Embodiments of the present invention may tag the video segment with a label that indicates whether “motion” was detected during acquisition of the video segment. As will be appreciated by skilled artisan, motion may be detected by a video processing algorithm running on the camera, or perhaps by an infra-red or other sensor attached to or in communication with the camera. In any case, the presence of motion in a particular video segment may be indicated by attaching a non-standard HTTP header designating motion. For example and without limitation, the “Sensr-Motion” header could be used to mark a video segment containing motion the following way.
curl -X POST -T seg01.ts -H “Sensr-Motion: true”-H “Sensr-Date: 2012-06-01T08:30:59 Z”-H “Content-Type: video/mp2ts” http://vxp01.sensr.net/upload/cam446

The absence of motion may be indicated with a “false” value, or perhaps the absence of the label altogether.
curl -X POST -T seg01.ts -H “Sensr-Motion: false”-H “Sensr-Date: 2012-06-01T08:30:59 Z”-H “Content-Type: video/mp2ts” http://vxp01.sensr.net/upload/cam446

The presence of motion might signify an emergency event, or an intruder in a surveillance application, or any number of potentially significant events determined by a user. Segments lacking motion might be discarded by a video archive system to obtain a cost savings.

A camera may also possess information about the region (e.g., a Cartesian coordinate or polar reference frame) of a video segment in which motion occurred. A non-standard HTTP header could be used to designate a bounding box, for example and not by way of limitation of the form “x1, y1, x2, y2”, where x1, y1 designate the top-left of the bounding box, and x2, y2 designate the lower-right of the bounding box. The origin 0, 0 is assumed to be in the top-left of the video image. For example, the “Sensr-ROI” header could be used to mark the region-of-interest for a video segment in the following way.
curl -X POST -T seg01.ts -H “Sensr-ROI: 10,10,100,100” -H “Sensr-Motion: true”-H “Sensr-Date: 2012-06-01T08:30:59 Z”-H “Content-Type: video/mp2ts” http://vxp01.sensr.net/upload/cam446

The example above marks a region of interest with a top-left coordinate of 10, 10 and a bottom-right coordinate of 100, 100. Regions of interest need not be static throughout the duration of the video segment. It is possible, and even likely, that an extended ROI format could be developed for specifying multiple ROI's on a second-by-second or frame-by-frame basis, or in whatever way a user desires.

In accordance with further embodiments of the present invention, cameras may have sensors to monitor environmental conditions, e.g., temperature, humidity or light-level of a space. Embodiments of the present invention may use such environment meta-data in the HTTP headers of video-segments transferred from such a camera. A non-standard header such as “Sensr-Temperature” or “Sensr-Lightlevel” could be used. A rapid change in temperature may signify an emergency event, or an unexpected change in light level might signify an intruder in a darkened space. There may be other uses for collecting these types of information.

The curl command above could be augmented with additional non-standard headers of the following form.
-H “Sensr-Temperature: 71.2F”
-H “Sensr-Lightlevel: 200 Lumens”

A PIR (Passive-Infrared) sensor detects the presence of a body. Such sensors are tuned to detect a human body and to ignore smaller bodies (such as those of pets). PIR sensors are used for security applications, or to control lighting based on the occupancy of a room. The value of a PIR sensor could be attached as a non-standard HTTP header. A camera archiving system might apply special treatment to video segments with a PIR value set to “true.”
-H “Sensr-PIR: true”

In other embodiments of the present invention, the HTTP standard “Content-Type” header can be used to specify what is called the “container-format” for a segment of video. A container-format is another name for a file-format. The video segment itself has information about the way the video was encoded. Nonlimiting examples of encoding information include:
type of video codec was used, e.g, h264, h262
type of audio codec was used, e.g., AAC, PCM
frame-rate of the video
sample-rate of the audio, mono or stereo
length of the video segment
desired width and height of the video for playback

While these pieces of information can be discovered by analyzing the video using a Unix tool such as “ffprobe” [http://ffmpeg.org/ffprobe.html], embodiments of cameras, systems, architectures and methods of the present invention make it better, faster, easier, or cheaper to provide this information via non-standard HTTP headers so that routing or storing of the segment can be done without using “ffprobe”. For instance, non-standard HTTP headers may be used to place some of these pieces of information in the headers of the HTTP request. The use of headers may duplicate information already in the video, but the headers make this information much more readily obtainable by the live streaming server without the need to probe the video segment for the information.

By using the HTTP header mechanism described above, non-standard HTTP headers can be defined for a cloud system (e.g., Sensr.net cloud system) in the following way.
-H “Sensr-vcodec: H.264”
-H “Sensr-frame-rate: 30/1”
-H “Sensr-acodec: AAC”
-H “Sensr-sample-rate: 8000”
-H “Sensr-sample-fmt: s16”
-H “Sensr-duration: 9.98”
-H “Sensr-width: 640”
-H “Sensr-height: 480”

In the exemplary Sensr cloud-based video-camera archive system in accordance with embodiments of the present invention, the video camera is the encoder, and the web-browser or smart-phone app that displays the video is the ultimate decoder of the video. Along the way, the video is transferred through the internet, load-balanced in Sensr's load balancers and received by the Sensr segment server. From there, the segments may be re-transmitted as “live” segments, or saved in cloud archive storage for review later, as previously discussed. The servers that construct the manifest files for display of the segments can operate smoothly and efficiently using meta-information about each of the segments. Embodiments of the present invention remove the decode step (using “ffprobe”), resulting in a more efficient in time and less costly system.

As described above, prior art systems combine or aggregate the serving of live and archived video leading to undesired latency. The disaggregated system, in accordance with embodiments of the present invention, reduces the latency to serve live segments, because of the time required to transfer the segments to cloud storage (or other archive storage, such as memory on a dedicated server) and index them in the database for later retrieval. Additionally, cloud storage space costs money. In one embodiment of the present invention segments without desired information (e.g., no motion within the segments) are discarded from the archive (but preferably not the live stream), thereby reducing the amount of cloud storage space. The end user can benefit from this reduced latency and reduction in storage space requirement. It is believed that serving segments from local live streaming server 202 instead of serving the most recently archived segments from cloud storage will result in reduced latency by virtue of removing the archiving step. An additional advantage of serving segments from live streaming server 202 is that live streaming server 202 saves only a few segments and expires them quickly, thereby reducing the memory footprint of live streaming server 202 reducing its CPU or GPU use. Cloud storage of prior art architectures and methods have a higher cost both in time, memory and CPU/GPU utilization. Additionally, architecture and methods in accordance with embodiments of the present invention tag the video segments at or close to the time of acquisition with information useful to the end user of such segments. The segments may be tagged with meta data identifying, for example and not by way of limitation, the time the video segment was actually acquired, whether motion had taken place within the video segment and the environmental conditions at the time of video acquisition. Tagging the segments with this contemporaneous information increases the efficiency of handling the video segments and ultimately reduces the costs and latency.

Archiving System 205, in accordance with some embodiments, is relieved of serving live video which has certain cost benefits over dual purposing or aggregating the archiving system to serve the live video, as in the prior art. Even though the archiving system serves higher latency live video than the live streaming server, it must still retain all the data necessary to serve the most recent segments as live video. Disaggregating archiving system 205 from live streaming server 202 has cost benefits. Segments that are available for live viewing from live streaming server 202 may be disposed of by archiving system 205 and never actually get stored because the disposed segments do not have information necessitating storage. Embodiments of the present invention that tag the segments with this information at or close to the time of acquisition increase the efficiency the system, and provides the ability to use much more robust information (e.g., motion, time, environmental conditions etc.). This gives the user the benefit of reduced-latency live viewing without incurring the increased cost of archiving all segments where some segments may not provide any useful information. For example, and not by way of limitation, in an embodiment if recording a parking lot where no cars come in or leave, the scene would be static and entire segments would be redundant information and could be deleted, thereby reducing the cloud storage or other storage space required to archive the relevant data. Change in lighting or the use of heat sensors can be used to identify when people are present. Additionally, the archiving system may package multiple segments into larger archives for additional cost savings in cloud storage. The time it takes to gather the pieces of these archives can be masked in the offline processing.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A computer architecture for serving reduced latency video and for archiving the video for later retrieval, said computer architecture comprising:
a live streaming server to receive a video segment from a camera, the live streaming server comprising a transfer/push module and a live segment buffer, wherein transfer/push module pushes the video segment to the live segment buffer;
an archiving system, wherein the transfer/push module transfers the video segment to the archiving system.

2. The computer architecture according to claim 1 further comprising:
a live manifest residing in the live streaming server, wherein the manifest comprises at least a subset of the most recent video segments from the live segment buffer to serve to a video viewer.

3. The computer architecture according to claim 1, wherein the archiving system comprises an archiving system for receiving the video segment from the transfer/push module, wherein the archiving system processes the video segment for transfer to a cloud storage system and for saving segment location data within the cloud storage system to a database.

4. The computer architecture according to claim 3, wherein the archiving system further comprises the database.

5. A method for serving reduced latency video and for archiving the video for later retrieval, the method comprising:
receiving a video segment from a video camera;
pushing the video segment to a live segment buffer; and
transferring the segment to an archiving system.

6. The method according to claim 4 wherein said video segment comprises meta-data.

7. The method according to claim 6, wherein said video camera generates said meta-data.

8. The method according to claim 6 further comprising generating meta-data for said video segment following said receiving step.

9. The method according to claim 6, wherein a web-browser GET command composes a manifest of the most recent segments from the live segment buffer.

10. The method according to claim 6, wherein said meta-data is stored and utilized separate from said video segment.

11. The method according to claim 6, wherein the archiving system transfers the video segment to a cloud, and stores the location of the video segment in a database, and wherein a GET command from a viewer locates a desired video segment in the database and accesses it from the cloud.

12. The method according to claim 11, wherein the archiving system analyzes the video segment to determine if it comprises information necessary for storage.

13. A video camera, wherein said video camera comprises hardware or firmware to achieve a process comprising:
segmenting a video into a segment;
obtaining information at approximately a time of acquisition of said segment,
generating meta-data for said segment from said information;
tagging said segment with said meta-data.

14. The video camera according to claim 13, wherein said information comprises an approximate time the segment was acquired.

15. The video camera according to claim 13, wherein said obtaining information comprises reading a sensor located on said video camera.

16. The video camera according to claim 15, wherein said sensor provides information for an environmental condition at approximately the time the segment was acquired.

17. The video camera according to claim 15, wherein said sensor determines when a live human body is present in said segment by measuring temperature.

18. The video camera according to claim 16, wherein said sensor measures approximate ambient temperature.

19. The video camera according to claim 16, wherein said sensor determines when motion takes place within said segment.

20. The video camera according to claim 13, wherein said obtaining information comprises analyzing said segment for motion.

21. The video camera according to claim 16, wherein said environmental condition comprises temperature, humidity, or barometric pressure.

22. A web-based video surveillance method comprising:
getting a video segment at a live streaming server, said video segment coming from a remotely located video camera;
pushing the video segment to a live segment buffer; and
transferring the segment to an archiving system
composing a manifest upon receipt of a GET command from a viewer on the web;
serving said manifest to said viewer.

23. The method according to claim 22 wherein said video segment comprises meta-data.

24. The method according to claim 23, wherein said video camera generates said meta-data.

25. The method according to claim 23 further comprising generating meta-data for said video segment following said receiving step.

26. The method according to claim 25, wherein said meta-data is transferred using HTTP headers.

27. The method according to claim 22, wherein said manifest comprises the most recent segments from the live segment buffer.

28. The method according to claim 22, wherein said manifest comprises segments from the archiving system.
